(19) United States
(12) Patent Application Publication
(10) Pub. No.: US 2006/0227296 A1
(43) Pub. Date: Oct. 12, 2006

(54) Light projector

(75) Inventors: Martin Dobler, Dusseldorf (DE); Dirk Pophusen, Bergisch Gladbach (DE); Matthias Boll, Koln (DE); Paul Platte, Clarkston, MI (US); Doug Stratton, Auburn Hills, MI (US)

Correspondence Address: BAYER MATERIAL SCIENCE LLC, 100 BAYER ROAD, PITTSBURGH, PA, 15205, US

(73) Assignees: Bayer MaterialScience AG; Bayer MaterialScience LLC

(21) Appl. No.: 11/397,862

(22) Filed: Apr. 3, 2006

(30) Foreign Application Priority Data
Apr. 6, 2005 (DE) 102005015904.4

(51) Int. Cl. G03B 21/00

(52) U.S. Cl. 353/33

(57) ABSTRACT

A light-projector that enables its de-icing or removal of condensation water therefrom and thus suitable as, among others headlights, searchlights, spotlights and floodlights is disclosed. The structure of the light-projector includes a housing having a light-exit aperture a cover lens for covering the light-exit aperture, a light source and a heating device, wherein said heating device is a source of infrared radiation.

### FIELD OF THE INVENTION

The invention relates to a light-projector and in particular to a light projector equipped with a heating device.

### BACKGROUND OF THE INVENTION

Light-projectors—such as, for example, front lights, rear lights and other illuminating devices for motor vehicles—do not, as a rule, require a special de-icing appliance or an appliance for the avoidance of misting, provided that use is made of conventional halogen lamps or gas-discharge lamps. These lamps produce sufficient heat to thaw ice and snow and to remove misting by condensation water. On the other hand, light-projectors with cold lighting means such as light-emitting diodes (LEDs), or even light-projectors with xenon lamps, do not generate a sufficient amount of heat and therefore display a defrosting power that is too low. Icing or misting on the cover lens of light-projectors is troublesome not only for aesthetic reasons. For safety reasons, the beam of light should not be attenuated or scattered when emerging from the light-projector.

A vehicle headlamp is known from DE 103 46 270 A, in the housing of which a heating device, preferably a PTC (positive temperature coefficient) heating element, is arranged. In DE 103 46 270 A a combination is also described of a PTC heating element with a conventional light source that has a large infrared component, such as halogen lamps for example. A principal advantage of LED headlamps, however, is the smaller construction space and the greater design freedom. A combination of halogen and LED headlamps is therefore not desirable.

JP 2003197013 A describes the incorporation of heating wires into the cover lens. But conventional heating wires are clearly visible and are unacceptable for aesthetic reasons. What are desired are appliances for the de-icing that are not visible or that are difficult to discern.

The object of the present invention is to provide a light-projector, in particular for vehicles, that enables de-icing or removal of condensation water in simple manner. The de-icing appliance is to be invisible or difficult to discern. The object is achieved, according to the invention, by using an infrared radiation source as the heating device.

### SUMMARY OF THE INVENTION

A light-projector that enables its own de-icing or removal of condensation water therefrom and thus suitable as, among others headlight, searchlight, spotlight and floodlight is disclosed. The structure of the light-projector includes a housing having a light-exit aperture, a cover lens for covering the light-exit aperture, a light source and a heating device, wherein said heating device is a source of infrared radiation.

### DESCRIPTION OF THE FIGURE

FIG. 1 is a schematic representation of an embodiment of the inventive light projector.

### DETAILED DESCRIPTION OF THE INVENTION

The invention provides a light-projector, in particular for vehicles, comprising a light-projector housing with a light-exit aperture, a cover lens for covering the light-exit aperture, a light source and an additional infrared radiation source as a heating device.

Included in the term “light-projectors” are all searchlights, spotlights, floodlights and headlamps, in particular vehicle headlamps. In a preferred embodiment, the light source is one or more light-emitting diodes.

The cover lens for covering the light-exit aperture may be any transparent material and its surface may be structured or unstructured. The cover lens may be constructed from several layers. Suitable materials include silicate glasses and transparent thermoplastics. The thermoplastics may be lacquered or unlacquered. Commercial scratch-resistant lacquers, for example those based on siloxane, polyurethane or acrylate are among the ones suitable.

Suitable thermoplastics include polycarbonates or copolycarbonates based on diphenols, polyacrylates or copolyacrylates and polymethacrylates or copolymethacrylates, preferably polymethyl methacrylate, polymers or copolymers with styrene, preferably transparent polystyrene or polystyrene acrylonitrile (SAN), transparent thermoplastic polyurethanes, and also polyolefins, preferably transparent polypropylene types, or polyolefins based on cyclic olefins (e.g. Topas®, a product of Ticona), polycondensates or copolycondensates of terephthalic acid, preferably polyethylene terephthalate or copolyethylene terephthalate (PET or COPET) or glycol-modified PET (PETG).

Particularly preferred materials for light-projector cover lens are silicate glass, bisphenol A polycarbonate, copolycarbonates formed from bisphenol A and 1,1-bis(4-hydroxyphenyl)-3,3,5-trimethylcyclohexane, and also polymethyl methacrylates and co-methyl methacrylates.

According to the invention, the heating is provided by an infrared radiation source positioned in the light-projector housing. Preferred are infrared radiation sources (IR radiation sources) with an emission maximum within the range of 800 to 30 000 nm, preferably within the range of water absorption of 1500 to 5000 nm or within the range of an absorption band of the material to be heated. Heating by infrared radiators is distinguished by high economic efficiency, since the heat energy is transmitted by electromagnetic radiation. The irradiated body absorbs the infrared radiation and converts it into heat. By way of radiation source, use may be made of IR lasers, IR LEDs or resistance-based IR radiators such as, for example, those described in DE 3 927 264 A. These may be employed in the form of tubular radiators, bulb-shaped radiators or point emitters. By reason of the robustness and possible high energy efficiency, as well as the comparatively high power with small physical size, resistance-based IR radiators are preferred.

The infrared radiation source is preferably directed towards the cover lens in such a way that at least some regions of the cover lens are irradiated. This may be effected, for example, in direct manner, by the IR radiation source being positioned in appropriate manner and by the principal emission taking place in the direction of the cover lens. However, this may alternatively also be effected in indirect manner, by the IR radiation either being focused onto regions of the cover lens or being distributed over a larger area of the cover lens, by means of a suitable arrangement of metallic or ceramic reflectors. Convective heat that is generated by resistance-based IR radiators may likewise serve for heating the light-projector.

The arrangement of the LED heating element or elements depends on the particular design of the light-projector. A preferred arrangement is one in which the IR radiation impinges on the cover lens with as little loss as possible due to scattering, absorption or reflection.

Commercial IR radiation sources may be employed. An example of a suitable IR radiation source is the IR emitter IR-12K manufactured by Scitec, Redruth, United Kingdom.

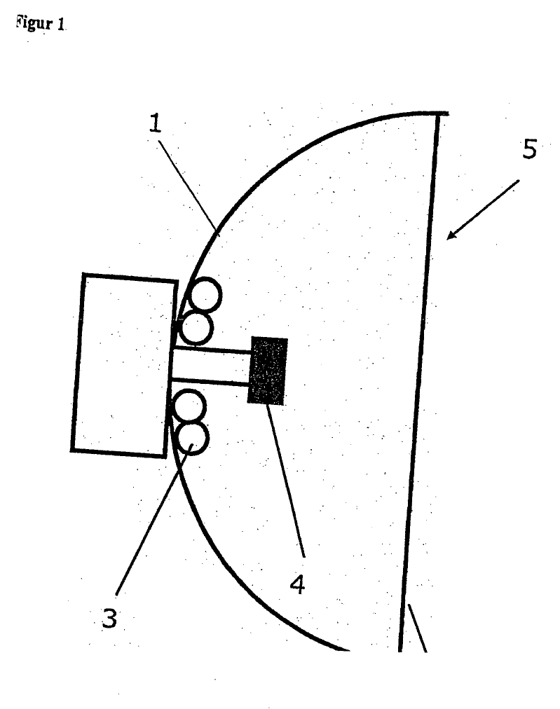

An embodiment of a light-projector according to the invention is represented in the appended FIG. 1. The light-exit aperture 5 of the light-projector housing 1 is provided with a cover lens 2. Four LEDs 3 are provided in the light-projector housing 1. An infrared radiation source 4 is provided within the housing 1. The infrared radiation source 4 is arranged in such a way that the infrared radiation is directed towards the cover lens 2. One or more IR radiation sources may be arranged in a similar position. Other positions of the IR radiation source(s) within the light-projector housing 1 are also possible, provided that the IR radiation source is oriented in such a way that the IR radiation is directed towards the cover lens. For example, the IR radiation source may be positioned behind the cover lens, adjacent to the latter.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A light-projector comprising a light-projector housing having a light-exit aperture a cover lens for covering the light-exit aperture, a light source and an additional heating device, wherein said heating device is an infrared radiation source.

2. The light-projector according to claim 1, wherein the position of the infrared radiation source is calculated to direct its radiation towards the cover lens.

3. The light-projector according to claim 1 wherein the light source is a light-emitting diode.
